(19) United States
(12) Patent Application Publication
(10) Pub. No.: US 2021/0199437 A1
(43) Pub. Date: Jul. 1, 2021

(54) VEHICULAR COMPONENT CONTROL USING MAPS

(71) Applicant: Intelligent Technologies International, Inc., Miami Beach, FL (US)

(72) Inventors: David S Breed, Miami Beach, FL (US); Wendell C Johnson, San Pedro, CA (US); Olexander Leonets, Kyiv (UA); Wilbur E DuVall, Katy, TX (US); Oleksandr Shostak, Kyiv (UA); Vyacheslav Sokurenko, Kyiv (UA)

(73) Assignee: Intelligent Technologies International, Inc., Miami Beach, FL (US)

(21) Appl. No.: 16/066,727

(22) PCT Filed: Jan. 9, 2017
(86) PCT No.: PCT/US2017/012745

§ 371 Date: Jun. 28, 2018

Related U.S. Application Data
(60) Provisional application No. 62/276,481, filed on Jan. 8, 2016.

(51) Int. Cl. G01C 21/16; G01C 21/36; G06F 16/29; G06N 3/02

(52) U.S. Cl. CPC G01C 21/1656; G01C 21/3602; G06N 3/02; G01C 21/367; G06F 16/29; G01C 21/3644

(57) ABSTRACT

Method and system for adjusting a vehicular component based on vehicle position includes obtaining kinematic data from an inertial measurement unit (IMU), deriving, using a processor, information about current vehicle position from the data obtained from the IMU and an earlier known vehicle position, and adjusting the derived current vehicle position to obtain a corrected current vehicle position. The latter is achieved by obtaining images of an external vehicle area using a camera assembly in a fixed relationship to the IMU, identifying multiple landmarks in each image, analyzing each image to derive positional information about each landmark, identifying discrepancies between image-derived positional information about each landmark and positional information about the same landmark obtained from a map database, and adjusting the derived current vehicle position based on identified discrepancies to obtain the corrected current vehicle position. Operation of the component is changed based on the corrected current vehicle position.

### TECHNICAL FIELD

The present invention relates generally to systems, arrangements and methods for using maps and images to locate a vehicle as a Global Navigation Satellite System (GNSS) replacement, and then using the vehicle location to control one or more vehicular components, such as a display of a navigation system, a vehicle steering or guidance system, a vehicle throttle system and a vehicle braking system. Route guidance and autonomous vehicle operation using highly accurate vehicle position determination is provided.

### BACKGROUND ART

A detailed discussion of background information is set forth in U.S. Pat. Nos. 6,405,132, 7,085,637, 7,110,880, 7,202,776, 9,103,671, and 9,528,834. Additional prior art of relevance includes U.S. Pat. Nos. 7,456,847, 8,334,879, 8,521,352, 8,676,430 and 8,903,591.

### SUMMARY OF THE INVENTION

Method and system for adjusting a vehicular component based on highly accurate vehicle position includes obtaining kinematic data from an inertial measurement unit (IMU) on the vehicle, deriving, using a processor, information about current vehicle position from the data obtained from the inertial measurement unit and an earlier known vehicle position, and adjusting, using the processor, the derived current vehicle position to obtain a corrected current vehicle position. This latter step entails obtaining at least one image of an area external of the vehicle using at least one camera assembly on the vehicle, each being in a fixed relationship to the IMU, identifying multiple landmarks each obtained image, analyzing, using the processor, each image to derive positional information about each landmark, obtaining from a map database, positional information about each identified landmark, and identifying, using the processor, discrepancies between the positional information about each landmark derived from each image and the positional information about the same landmark obtained from the map database. Finally, the derived current vehicle position is adjusted using the processor based on the identified discrepancies to obtain the corrected current vehicle position which is used to change operation of the vehicular component.

Various hardware and software elements used to carry out the invention described herein are illustrated in the form of system diagrams, block diagrams, flow charts, and depictions of neural network algorithms and structures

### BRIEF DESCRIPTION OF DRAWINGS

Preferred embodiments are illustrated in the following figures:

FIG. 1 illustrates a WADGNSS system with four GNSS satellites transmitting position information to a vehicle and to a base station which in turn transmits directly or indirectly a differential correction signal to a vehicle.

FIG. 2 is a diagram showing a combination of a GNSS system and an inertial measurement unit (IMU).

FIG. 3A illustrates a vehicle with a camera and two GNSS antennas plus an electronics package for operating the system in accordance with the invention.

FIG. 3B is a detail of the electronics package shown in FIG. 3A,

FIG. 3C is a detail of the camera and GNSS antenna shown in FIG. 3A.

FIG. 3D illustrates use of two cameras.

FIG. 4A is an implementation of the invention using a GoPro® camera and FIG. 4B illustrates the use of 2 GoPro® cameras which are not collocated.

FIG. 5A illustrates a first embodiment wherein a system in accordance with the invention is integrated into a production vehicle with camera assemblies incorporated into A-Pillars of the vehicle.

FIG. 5B illustrates an embodiment similar to that shown in FIG. 5A, wherein a system in accordance with the invention incorporates a third camera providing an approximate 180 degree total field of view (FOV).

FIG. 5C illustrates an embodiment similar to that shown in FIG. 5A, wherein a system in accordance with the invention includes two collocated camera assemblies.

FIG. 6 is a block diagram of electronics system of FIG. 3B.

FIG. 7 is a flowchart on how IMU errors are corrected using photogrammetry to eliminate the need for the GNSS satellites allowing a vehicle to locate itself using landmarks and a map.

FIG. 8 is a flow chart with calculations done in the cloud for map creation.

FIG. 9 is a flowchart with calculations done on vehicle for image compression.

FIG. 10A illustrates lens image barrel distortions and FIG. 10B illustrates distortions caused when a rolling shutter camera is used.

### BEST MODE FOR CARRYING OUT INVENTION

The illustrated embodiments may be considered together as part of a common vehicle.

### 1. Accurate Navigation General Discussion

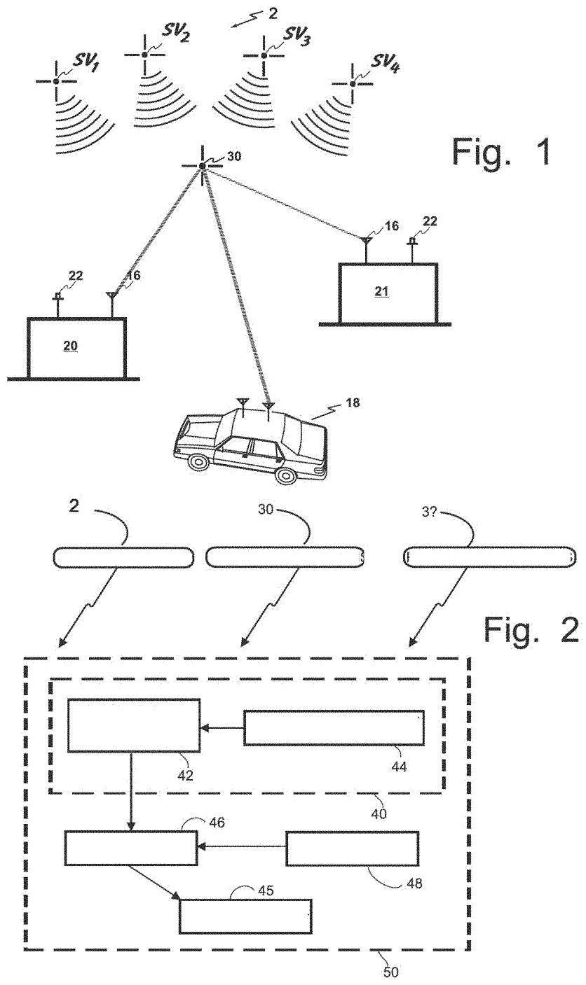

FIG. 1 illustrates a prior art arrangement of four satellites 2 designated SV₁, SV₂, SV₃ and SV₄ of a GNSS, such as GPS, satellite system transmitting position information to receivers of base stations 20 and 21, such as by an antennas 22 associated with the base stations 20, 21. Base stations 20, 21 transmit a differential correction signal via associated transmitters station, such as a second antenna 16, to a geocentric or low earth orbiting (LEO) satellite 30 or to the Internet by some other path. LEO satellite 30 transmits differential correction signals to a vehicle 18 or corrections are obtained from the Internet or some other convenient path. For WADGNSS, one or more of base stations 20, 21 receives and performs a mathematical analysis on all signals received from a number of base stations 20, 21 that cover the area under consideration and forms a mathematical model of the errors in the GNSS signals over the entire area.

FIG. 2 is a diagram of a system 50 showing a combination 40 of the GNSS and DGNSS (differential global navigation satellite system) processing systems 42 and an inertial measurement unit (IMU) 44. The GNSS system includes a unit for processing received information from satellites 2 of the GNSS satellite system (shown in FIG. 1), information from the LEO satellites 30 of the DGNSS system and data from IMU 44. IMU 44 preferably contains one or more accelerometers and one or more gyroscopes, e.g., three accelerometers and three gyroscopes. Also, IMU 44 may be a MEMS-packaged IMU integrated with the GNSS and DGNSS processing systems 42 which serve as a correction unit.

Map database 48 works in conjunction with a navigation system 46 to provide information to the driver of the vehicle 18 (see FIG. 1) such as his/her location on a map display, route guidance, speed limit, road name etc. It can also be used to warn the driver that the motion of the vehicle is determined to deviate from normal motion or operation of the vehicle.

Map database 48 contains a map of the roadway to an accuracy of a few centimeters (1 σ), i.e., data on the edges of the lanes of the roadway and the edges of the roadway, and the location of all stop signs and stoplights and other traffic control devices such as other types of road signs. Motion or operation of the vehicle can be analyzed relative to the data in the map database 48, e.g., data about edges of travel lanes, instructions or limitations provided or imposed by traffic control devices, etc., and a deviation from normal motion or operation of the vehicle detected.

Navigation system 46 is coupled to the GNSS and DGNSS processing system 42. The driver is warned if a warning situation is detected by a vehicle control or driver information system 45 coupled to the navigation system 46. Driver information system 45 comprises an alarm, light, buzzer or other audible noise, and/or a simulated rumble strip for yellow line and “running off of road” situations and a combined light and alarm for the stop sign and stoplight infractions. Driver information system 45 may be a sound only or sound and vibration as in a simulated rumble strip.

A local area differential correction system known as Real Time Kinematic, or RTK, differential system is available and the system of choice for creating accurate maps. In this system, local stations are established which, over time, determine their exact location within millimeters. Using this information, the local stations can provide corrections to moving vehicles that are nearby, allowing them to determine their locations to within a few centimeters. RTK base stations determine their locations by averaging their estimated locations over time and thereby averaging out errors in the GNSS signals. By this method, they converge to an accurate position determination. When an RTK base station or vehicle determines location, it is meant that hardware and/or software at the RTK base station or at or on the vehicle is configured to receive signals or data and derive location therefrom. Where implemented, RTK stations are typically placed 30 to 100 kilometers apart. However, in urban locations where multipath problems are relevant, such stations may be placed as close as tens to hundreds of meters.

### 2. Map Creation, Description of the Photogrammetry Based Mapping System

Maps created from satellite photographs are available for most of the world. Such maps show the nature of topography including roads and nearby road structures. Accuracy of such roads is limited to many meters and such satellite-created maps are often insufficiently accurate for vehicle route guidance purposes, for example, and other purposes described herein. Various mapping companies provide significant corrections to maps through deployment of special mapping vehicles which, typically through use of lidar or laser-radar technology, created maps now in widespread use for route guidance, for example, by vehicles in many parts of the world. Such maps, however, are only accurate to a few meters.

Although this is sufficient for route guidance, additional accuracy is needed for autonomous vehicles guidance where centimeter level accuracy is required to prevent vehicles from crossing lane markers, running off the road, and/or impacting fixed objects such as poles, trees or curbs. This is especially a problem in low visibility conditions where laser radar system can be of marginal value. Techniques described herein solve this problem and provide maps to centimeter level accuracy.

An inventive approach is to accomplish the mapping function utilizing multiple probe vehicles, which are otherwise ordinary vehicles, each equipped with one or more cameras, an IMU and an accurate RTK DGNSS system as described below. Such a system can be called crowdsourcing. A receiver for obtaining WADGNSS, such as provided by OmniSTAR corrections is also preferably available on the vehicle for use in areas where RTK DGNSS is not available.

As each probe vehicle traverses a roadway, each camera thereon obtains images of the space around the vehicle and transmits these images, or information derived therefrom, to a remote station off of the vehicle, using a transmitter, which may be part of a vehicle-mounted communication unit. This communication can occur in any of a variety of ways including a cellphone, the Internet using broadband such as WiMAX, LEO or GEO satellites or even Wi-Fi where it is available or any other telematics communication system. The information can also be stored in memory on the vehicle for transmission at a later time.

The remote station can create and maintain a map database from information transmitted by probe vehicles. When a section of roadway is first traversed by such a probe vehicle, the remote station can request that a full set of images be sent from the probe vehicle depending on available bandwidth. When sufficient bandwidth is unavailable, images can be stored on the vehicle, along with position information, for later uploading. Additional images can also be requested from other probe vehicles until the remote station determines that a sufficient image set has been obtained, i.e., a processor configured to process images at the remote station determines that a sufficient image set has been obtained. Thereafter, the probe vehicles can monitor terrain and compare it to the on-vehicle map (from map database 48) and notify the remote site if discrepancies are discovered.

If a GNSS receiver is placed at a fixed location, with appropriate software, it can eventually accurately determine its location without the need for a survey. It accomplishes this by taking a multitude of GNSS data and making a multitude of position estimates, as GNSS satellites move across the sky, and applying appropriate algorithms that are known in the art. By averaging these position estimates, the estimated position gradually approaches the exact position. This is a method by which local RTK stations are created. This process can get more complicated when known and invariant errors are present. Software exists for removing these anomalies and, in some cases, they can be used to improve position accuracy estimates.

In a probe vehicle, corrected or uncorrected GNSS signals are used to correct drift errors in the IMU 44 and it is the IMU 44 which is used by the vehicle to provide an estimate of its position at any time. If the GNSS signals are the only available information, then the vehicle location, as represented by IMU 44, will contain significant errors on the order of many meters. If WADGNSS is available, these errors are reduced to on the order of a decimeter and if RTK DGNSS is available, these errors are reduced to a few centimeters or less.

When a probe vehicle acquires an image, it records position and pointing angle of the camera as determined by the IMU 44. Position and pointing angle are used to determine a vector to a point on an object, the landmark, in the image such as a pole. After two images are obtained, location of the pole can be determined mathematically as the intersection of the two vectors to the same point on the pole. This location will be in error due to the accuracy of the IMU 44 and the accuracies in the imaging apparatus.

Since imaging apparatus errors are invariant, such as imperfections in the lenses, they can be mostly removed through calibration of the apparatus. Distortion due to lens aberrations can be mapped and corrected in software. Other errors, due to barrel distortions or due to the shutter timing in a rolling shutter camera, can similarly be removed mathematically. Remaining errors are thus due to the IMU 44. These errors are magnified based on distance between, e.g., the vehicle and pole.

In the same manner as the fixed GNSS RTK receiver gradually determines its exact location through averaging multiple estimates, location of the reference point on a pole can similarly be exactly determined by averaging position estimates. When the IMU location is determined only using GNSS readings, a large number of position estimates are required since the IMU errors will be large. Similarly, if WADGNSS is available, fewer position estimates are necessary and with RTK DGNSS, only a few position estimates are required. This process favors use of nearby poles due to the error magnification effect but even further away poles will be accurately located if sufficient position estimates are available.

It takes two images to obtain one position estimate, provided the same landmark is in both images. Three images provide three position estimates by combining image 1 with image 2, image 1 with image 3 and image 2 with image 3. The number of position estimates grows rapidly with the number of images n according to the formula n*(n−1)/2. Thus, forty-five position estimates are obtained from ten images and 4950 position estimates from one hundred images.

Initially, multiple images can be obtained by a single probe vehicle but, as the system becomes widely adopted, images from multiple probe vehicles can be used, further randomizing any equipment systemic errors which have not been successfully removed.

A pole is one example of a landmark to be used in the creation of accurate maps as taught herein. Other landmarks include any invariant (fixed in position) structure with a characteristic which can be easily located, such as the right edge or center of a pole at its midpoint, top or at a point where the pole intersects the ground, or any other agreed upon reference point. Examples of other landmarks are edges of buildings, windows, curbs, guardrails, road edges, lane markers or other painted road markings, bridges, gantries, fences, road signs, traffic lights, billboards and walls.

Landmarks may be limited to man-made objects; however, in some cases, natural objects such as rocks and trees can be used. In many landmarks, a particular point, such as the midpoint or top of a pole, needs to be selected as a representative or position-representing point. Some landmarks, such as a curb, road edge or painted lane marker, do not have a distinctive beginning or end that appears in a single image. Even in such cases, the line does begin and end or is crossed by another line. Distance traveled from such a starting or crossing point can be defined as the representative point.

Some objects, such as trees and rocks, do not lend themselves to be chosen as landmarks and yet their placement on a map for safety reasons can be important. Such objects can be placed on the map so that vehicles can avoid impacting with them. For such objects, a more general location can be determined, but the object will not be used for map accuracy purposes.

Satellite-created maps are generally available which show the character of terrain. However, since satellite-created maps are generally not sufficiently accurate for route guidance purposes, such maps can be made more accurate using the teachings of this invention since location of landmarks discussed above, and that can be observed on the satellite-created maps, can be accurately established and the satellite-created maps appropriately adjusted so that all aspects of terrain are accurately represented.

Initially in the mapping process, complete images are transmitted to the cloud. As the map is established, only information relative to landmarks needs to be transmitted, greatly reducing the required bandwidth. Furthermore, once a desired accuracy level is obtained, only data relevant to map changes need to be transmitted. This is the automatic updating process.

Computer programs in the cloud, i.e., resident at a hosting facility (remote station) and executed by a processor and associated software and hardware thereat, will adjust satellite images and incorporate landmarks to create a map for various uses described herein. Probe vehicles can continuously acquire images and compare location of landmarks in those images with their location on the map database and when a discrepancy is discovered, new image data, or data extracted therefrom, is transmitted to the cloud for map updating. By this method, an accurate map database can be created and continuously verified using probe vehicles and a remote station in the cloud that creates and updates the map database. To facilitate this comparison, each landmark can be tagged with a unique identifier.

### 3. Map Enhancements Using Satellite Imaging and Supplemental Information

When processing multiple images at the remote station, using for example stereographic techniques with dual images, images or data derived from the images are converted to a map including objects from the images by identifying common objects in the images, for example by neural networks or deep learning, and using position and pointing information from when the images were obtained to place the objects on the map. Images may be obtained from the same probe vehicle, taken at different times and including the same, common object, or from two or more probe vehicles and again, including the same, common object.

By using a processor at the remote station, that is not located on the probe vehicles yet in communication with them, images from multiple vehicles or the same vehicle taken at different times may be used to form the map. In addition, by putting the processor separate from the probe vehicles, it is possible to use WADGNSS without having equipment to enable such corrections on the probe vehicles.

By using the method above, an accurate map database can automatically be constructed and continuously verified without the need for special mapping vehicles. Other map information can be incorporated in the map database at the remote station such as locations, names and descriptions of natural and man-made structures, landmarks, points of interest, commercial enterprises (e.g., gas stations, libraries, restaurants, etc.) along the roadway since their locations can have been recorded by probe vehicles.

Once a map database has been constructed using more limited data from probe vehicles, additional data can be added using data from probe vehicles that have been designed to obtain different data than the initial probe vehicles have obtained, thereby providing a continuous enrichment and improvement of the map database. Additionally, the names of streets or roadways, towns, counties, or any other such location based names and other information can be made part of the map.

Changes in the roadway location due to construction, landslides, accidents etc. can be automatically determined by the probe vehicles. These changes can be rapidly incorporated into the map database and transmitted to vehicles on the roadway as map updates. These updates can be transmitted by means of a ubiquitous Internet such as WiMAX, or equivalent, or any other appropriate telematics method. All vehicles should eventually have permanent Internet access which permits efficient and continuous map updating.

WADGNSS differential corrections can be applied at the remote station and need not be considered in the probe vehicles thus removing the calculation and telematics load from the probe vehicle. See, for example, U.S. Pat. No. 6,243,648. The remote station, for example, could know DGNSS corrections for the approximate location of the vehicle at the time that images or GNSS readings were acquired. Over time, the remote station would know exact locations of infrastructure resident features such as the pole discussed above in a manner similar to fixed GNSS receiver discussed above.

In this implementation, the remote station would know mounting locations of the vehicle-mounted camera(s), GNSS receivers and IMU on the vehicle and relative to one another and view angles of the vehicle-mounted camera(s) and its DGNSS corrected position which should be accurate within 10 cm or less, one sigma, for WADGNSS. By monitoring the movement of the vehicle and relative positions of objects in successive pictures from a given probe vehicle and from different probe vehicles, an accurate three-dimensional representation of the scene can be developed over time.

Once road edge and lane locations, and other roadway information, are transmitted to the vehicle, or otherwise included in the database (for example upon initial installation of the system into a vehicle), it requires very little additional bandwidth to include other information such as location of all businesses that a traveler would be interested in, such as gas stations, restaurants etc., which could be done on a subscription basis or based on advertising.

### 4. Description of Probe Mapping Vehicle Systems

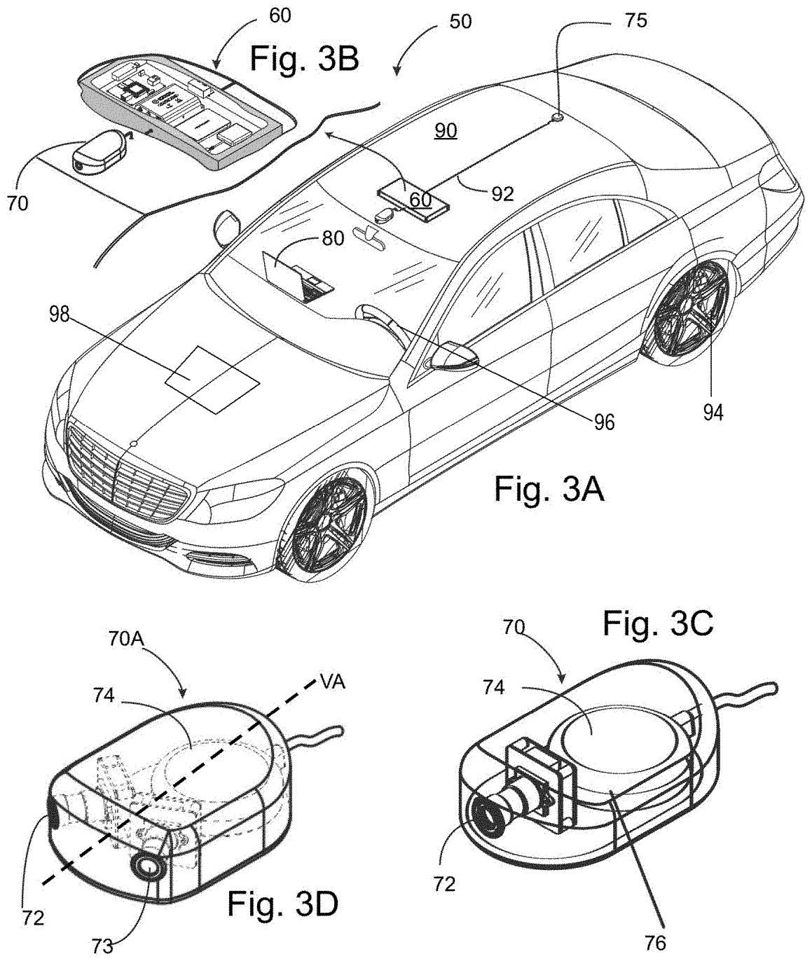

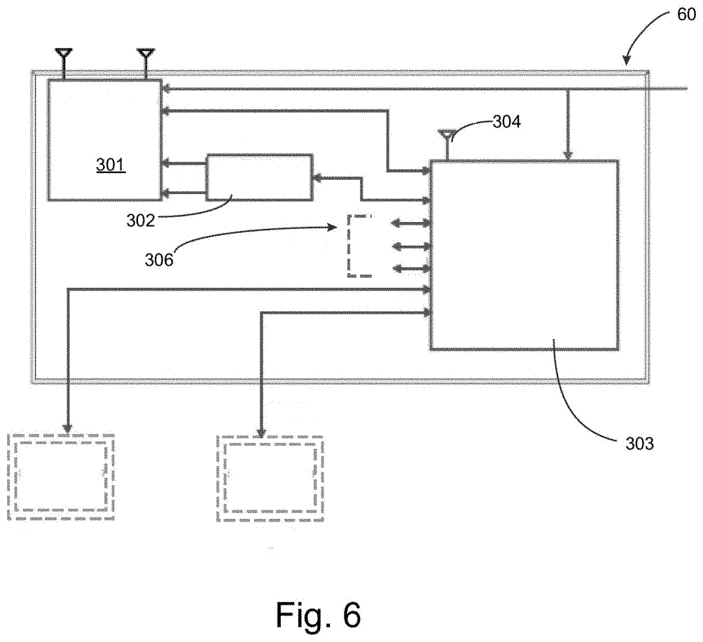

Considering now FIGS. 3A, 3B, 3C and 3D, of which FIG. 3A illustrates a camera assembly 70 and two GNSS antennas, one within the camera assembly 70 and the other 75 mounted at the rear of the vehicle roof 90, and which may be used with the arrangement shown in FIG. 2. Electronics package 60 attached to the underside of the roof 90 within the headliner (not shown) houses the operating system and various other components to be described below (FIG. 6). A coupling 92 connects electronics package 60 to antenna 75 at the rear of the roof 90. Camera assembly 70 is forward of electronics package 60 as shown in FIG. 3B.

FIG. 3C details camera assembly 72 and GNSS antenna 74 rearward of camera assembly 72 in the same housing 76. FIG. 3D illustrates an alternate configuration where two camera assemblies 72, 73 are used. The illustrated cameras may be commercially available See3CAM_CU130-13MP from e-con Systems http://www.e-consystems.conUltraHD-USB-Camera.asp. Each camera assembly 72, 73 is preferably equipped with a lens having a horizontal field of view of about 60 degrees and somewhat less in the vertical direction.

In FIG. 3D, a housing 70A includes the two camera assemblies pointed or oriented with their imaging direction in directions of plus and minus 30 degrees, respectively, relative to a vehicle axis VA extending halfway between openings of camera assemblies 72, 73. Thus, with each camera assembly 72, 73 having a 60 degree horizontal field of view (FOV), the assembly has a combined field of view of about 120 degrees. The chosen lens has a uniform pixel distribution. With 3840 pixels in the horizontal direction, this means that there will be approximately 64 pixels per degree. One pixel covers an area of about 0.81 cm by about 0.81 cm at a distance of about 30 meters. Most landmarks will be within 30 meters of the vehicle and many within 10 to 15 meters.

The two antennas 74, 75 provide information to a processor in electronics package 60 to give an accurate measurement of the vehicle heading direction or yaw. This can also be determined from the IMU when the vehicle is moving. If the vehicle is at rest for an extended time period, the IMU can give a poor heading measurement due to drift errors.

The components which make up electronics assembly 60 are shown in FIG. 6 and discussed in reference thereto below.

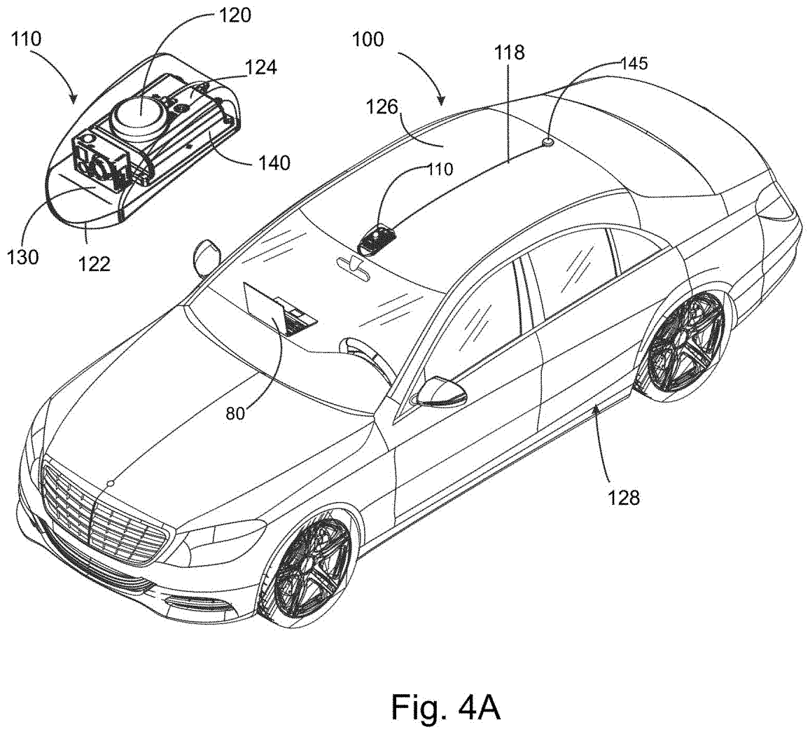

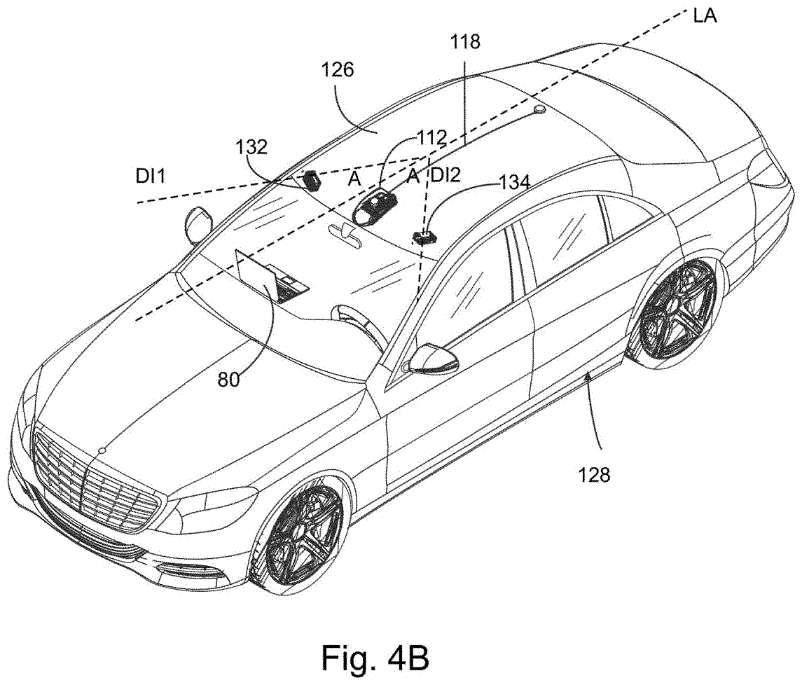

Additional systems in accordance with the invention are illustrated in FIG. 4A with a single camera assembly and in FIG. 4B with two camera assemblies which are separately located, i.e., spaced apart from one another. The system is illustrated generally at 100 in FIG. 4A and comprises a camera assembly 110 which comprises a GoPro HERO Black camera 130 or equivalent imaging device, an Advanced Navigation assembly 140, discussed below, and a GNSS antenna 120, all in a common camera assembly housing 122. Internal circuitry 124 connects antenna 120, camera 130 and navigation assembly 140 in the housing 122. Circuitry 124 may include a processor.

Assembly 110 is mounted onto the exterior surface of a roof 126 of a vehicle 128 along with a second GNSS antenna 145 coupled thereto by a coupling connector 118. Mounting means to provide for this mounting may be any known to those skilled in the art for attaching external vehicular components to vehicle body panels and roofs,

In FIG. 4B, two camera assemblies 132, 134 are placed on lateral sides of the exterior surface of roof 126 and rotated at an angle so that their FOVs do not significantly overlap (from the position shown in FIG. 4A wherein the field of view is substantially symmetrical about a longitudinal axis of the vehicle). This rotation results in a positioning of camera assemblies 132, 134 such that a longitudinal axis of each housing 122 is at an angle of about 30 degrees to the longitudinal axis of the vehicle. It is possible to construct the housing 122 to have its longitudinal axis substantially parallel to the longitudinal axis of the vehicle, but the camera assemblies angled with their imaging direction at an angle of about 30 degrees to the longitudinal axis of the vehicle. Thus, the configuration or positioning criteria is for the imaging directions DI1, DI2 of camera assemblies 132, 134, respectively, to be at an angle A of about 30 degrees to the longitudinal axis LA of the vehicle 128 (see FIG. 4B).

If 60 degree lenses are used in each camera assembly 132, 134, then the angle of rotation can be slightly less than about 30 degrees so that all areas within a 120 degree FOV except a small triangle in the center and in front of the vehicle are imaged. Navigation and antenna assembly 112 is shown mounted in the center of the exterior surface of roof 126.

An alternate configuration providing potentially greater accuracy is to move camera assemblies 132, 134 to positions that are as close as possible to the navigation and antenna assembly 112, moving navigation and antenna assembly 112 slightly rearward so that camera assemblies 132, 134 would be touching each other.

For some systems, a portable computing device, such as a laptop 80 as shown in FIG. 3, can be provided to receive, collect and process the image, navigation and IMU data. The laptop, or other processor, 80 may be resident in the vehicle as shown in FIG. 3 during use and removable from the vehicle when desired, or permanently fixed as part of the vehicle. Laptop 80 constitutes a display of a navigation system whose operation is changed by position determination according to the invention.

In some implementations, the only processing by laptop 80 is to tag received images with displacement and angular coordinates of the camera(s) providing each image and to update the IMU with corrections calculated from the navigation unit. The IMU may be part of the navigation unit. The images will then be retained on the laptop 80 and transferred either immediately or at some later time to a remote station via the telecommunications capability of the laptop 80.

At the remote station, there will likely be another processing unit that will further process the data to create a map. In other implementations, the images are processed by a computer program executed by the processing unit to search for landmarks using pattern recognition technology, such as neural networks, configured or trained to recognize poles and other landmarks in images. In this case, only landmark data needs to be transferred to the processing unit at the remote station for processing by the computer program. Initially the first process will be used but after the map is fully developed and operational, only landmark data that indicates a map change or error will need to be transmitted to the processing unit at the remote station.

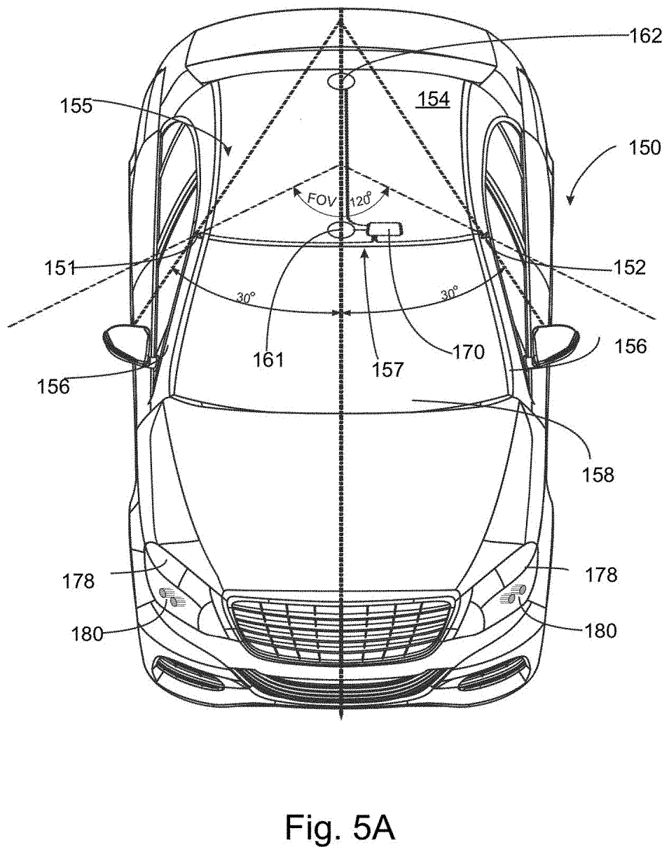

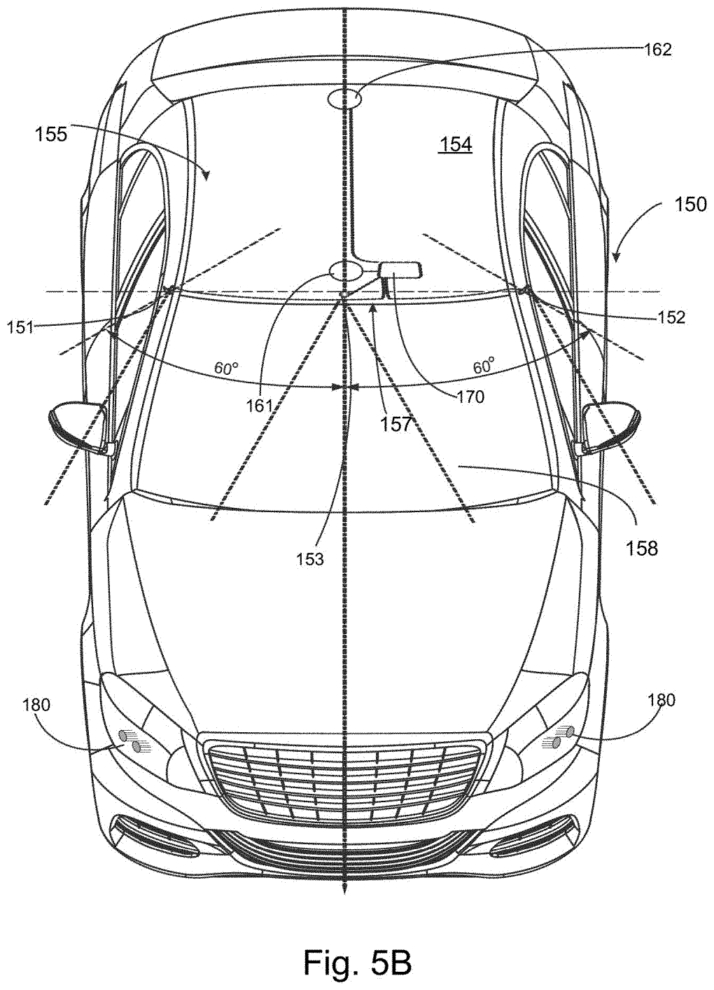

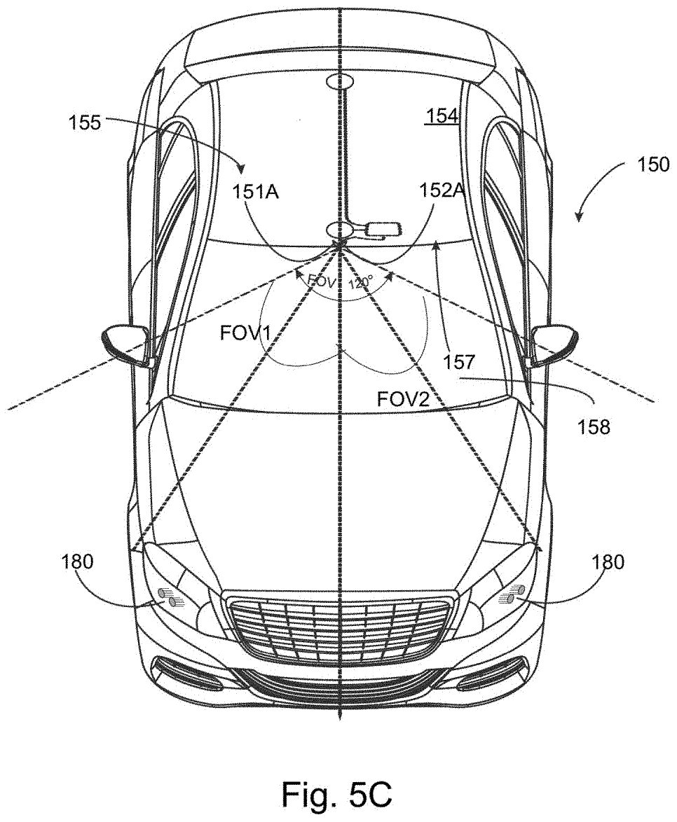

FIG. 5A illustrates integration of a mapping system of the invention into a production vehicle 150 with camera assemblies 151, 152 incorporated into A-Pillars 156 of vehicle 150. Antennas 161, 162 are integrated into or in conjunction with a surface 154 of roof 155 so that they are not visible. Navigation and other electronics is integrated into a smartphone-sized package 170 and mounted below roof 155 into a headliner 157 of vehicle 150.

FIG. 5B is similar to FIG. 5A and incorporates a third camera assembly 153 in headliner 157 thereby providing an approximate 180 degree total FOV.

FIG. 5C is similar to FIGS. 5A and 5B and illustrates an embodiment having two cameras 151A, 152A collocated in the center of the vehicle. The field of view of camera assembly 151A is designated FOV1 while the field of view of camera assembly 152A is designated FOV2, and with each of FOV1 and FOV2 being about 60 degrees, the total FOV is about 120 degrees. In FIGS. 5A, 5B and 5C, production intent designs of the system are presented which show that only lens of the camera assemblies 151, 151A, 152, 152A and 153 will be observable protruding from near the interface between windshield 158 and roof 155. From this location, a relatively large portion of each obtained image is blocked by roof 155 and windshield 158 and in particular much of the image would be lost for angles exceeding 60 degrees if, for example, a 90 degree lens were used. Since there is little to be gained from using a 90 degree lens and the number of pixels per degree would decrease to approximately 43 from 64, the 60 degree lens is preferred for these embodiments.

Cameras assemblies 151, 151A, 152, 152A and 153 do not need to be mounted at the same location and if they were placed at edges of the roof 155 at A-Pillar 156, as in FIG. 5B for example, then advantages of a different angle lens, such as 90 degrees, could be persuasive. The tradeoff here is in the registration of the camera assemblies with the IMU. The system relies for its accuracy on knowing the location and pointing direction of the camera assemblies which is determined by the IMU. If location of the camera assemblies and its pointing direction are not accurately known relative to the IMU, then errors will be introduced. The chance of an unknown displacement or rotation occurring between camera assemblies and IMU is greatly reduced if they are very close together and rigidly mounted to the same rigid structure. This is a preferred configuration and requires that the devices be mounted as close as possible together as illustrated in FIG. 5C for two camera assemblies and a FOV of 120 degrees.

When the system of this invention is used for determining vehicle location in poor visibility situations and displaying the vehicle location on display of laptop 80, IR flood lights 180 can be provided at the front on each side of vehicle 150 to augment the illumination of headlights 178 of vehicle 150. The camera assemblies in this case need to be sensitive to near IR illumination.

In some embodiments, additional cameras or wide angle lenses can be provided which extend the FOV to 180 degrees or more. This allows the system to monitor street view scenes and report changes.

The embodiments illustrated in FIGS. 5A, 5B and 5C preferably incorporate passive IR for location of vehicle 150 under low visibility conditions, such as at night.

Electronics used in box 60 of FIG. 3A are shown as a block diagram generally at 60 in FIG. 6. An important component of the electronics package 60 is the GNSS aided inertial navigation system including an Attitude and Heading Reference System (AHRS), collectively referred to herein as AN 301. The AHRS generally comprises sensors on three axes that provide attitude information including roll, pitch and yaw, otherwise known as the IMU. They are designed to replace traditional mechanical gyroscopic flight instruments and provide superior reliability and accuracy. A preferred system used herein is called the Spatial Dual and is manufactured by Advanced Navigation of Australia (https://www.advancednavigation.com.au). See the Advanced Navigation Spatial Dual Flyer available from Advanced Navigation for a more complete description of the AN 301.

When used with RTK differential GPS, horizontal position accuracy is about 0.008 m, vertical position accuracy is about 0.015 m and dynamic roll and pitch accuracy is about 0.15 degrees and heading accuracy is about 0.1 degree. When the system of this invention is in serial production, a special navigation device is provided having similar properties to the AN, potentially at a lower cost. Until such time, the commercially available AN may be used in the invention.

AN 301 contains the IMU and two spaced apart GNSS antennas. Antennas provide the ability to attain accurate heading (yaw) information. In addition, AN 301 contains a receiver for receiving differential corrections from OmniSTAR and RTK differential correction systems. Accurate mapping can be obtained with either system and even without any differential corrections; however, a greater number of images are required, the lower the position and angular accuracy that is available. When RTK is available, 10 cm pole position accuracy can be obtained on a single pass by an image acquiring vehicle whereas 10 passes may be required when only OmniSTAR is available and perhaps 50 to 100 passes when no differential corrections are available.

In FIG. 6, 302 represents the USB2 to GPIO General purpose input/output module, 303 the processor, 304 the Wi-Fi or equivalent communications unit and 306 the expansion USB ports for additional cameras (additional to the two cameras shown below the electronics package 60).

5. Determining Vehicle Location without Satellite Navigation Systems

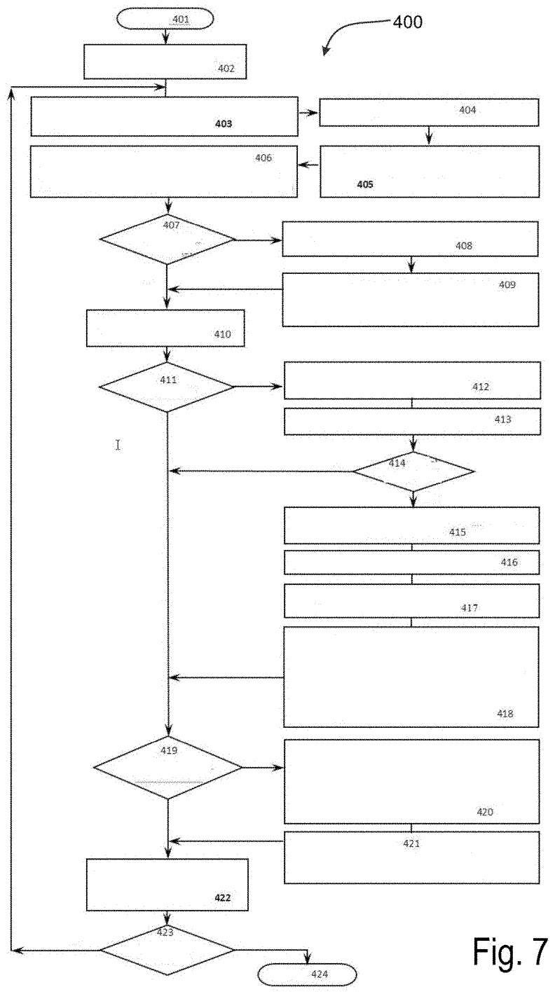

FIG. 7 is a flowchart showing a technique for correcting IMU errors using photogrammetry to eliminate the need for GNSS satellites, thereby allowing a vehicle to locate itself using landmarks and a map and cause display of the vehicle location on display of a navigation system such as run on laptop 80. Processing of IMU data is adjusted based on discrepancies between positional information about each landmark derived from image processing and positional information about the same landmark obtained from a map database. Raw IMU data and/or integrated raw IMU data (the displacements, roll, pitch and yaw integrated from raw IMU data) may be adjusted, both providing adjusted (error-corrected or error-compensated) displacement, roll, pitch and yaw. If the final result of integration of data from the IMU is erroneous by a certain amount (there is a difference between the two positional determinations for the same landmark), a coefficient that converts the measured property (acceleration/angular speed-step 403) into distance or angle (step 405) is applied to correct the error (e.g., in step 404). Such a coefficient is applied to raw data (step 403) or after integration of the raw data (step 405). The numerical value of the coefficient is different depending on when it is applied, and is based on the landmark position discrepancy analysis.

In the chart “FID” means landmark. The flowchart is shown generally at 400. Each of the steps is listed below. Step 401 is to begin. Step 402 is setting initial data, including the Kalman filter's parameters. Step 403 is IMU-data reading (detecting) with frequency 100 Hz: acceleration Ā, angular speed \vec{ω} (considered kinematic properties of the vehicle). Step 404 is error compensation for IMU. Step 405 is calculation of current longitude λ, latitude ϕ, altitude h, Roll, Pitch, Yaw, and linear speed \vec{V}_{gps}. Step 405 is generally a step of deriving, using a processor, information about current vehicle position from the data obtained from the IMU and an earlier known vehicle position by analyzing movement therefrom. Step 406 is reading GPS-data with GNSS or RTK correction (if available), detected with frequency 1, . . . , 10 Hz: longitude λgps, latitude ϕ gps, altitude hgps, linear speed \vec{V}_{gps}. Step 407 is a query as to whether there is new reliable GPS-data available. If so, step 408 is bringing the GPS and IMU measurements to common time (synchronization), and step 409 is calculation of the first observation vector: \vec{Y}₁=[(λ−λ_{gps})Rₑ·cos(ϕ_{gps}); (ϕ−ϕ_{gps})Rₑ; h−h_{gps}; \vec{V}−\vec{V}_{gps}] where Re=6371116 m is the average Earth radius. Thereafter, or when there is no new reliable GPS-data available in step 407, step 410 is taking an image (if available) with frequency 1, . . . , 30 Hz. Landmark processing for correct vehicle position may thus occur only when GPS-data is not available.

Step 411 is a query as to whether a new image is available. If so, step 412 is to preload information about landmarks, previously recognized at current area, from the map, step 413 is identification of known landmarks Nj, j=1, . . . , M, and step 414 is a query as to whether one or more landmark(s) is/are recognized in the image. If so, step 415 is retrieving coordinates λⱼ, ϕⱼ, hⱼ of the j-th landmark from the map (database), step 416 is calculating local angles [symbol] ⱼ and γⱼ of the landmark, step 417 is bringing the IMU measurements to time of the still image (synchronization), and step 418 is calculation of the second observation vector: \vec{Y}₂=[\vec{Y′}₁; . . . ; \vec{Y′}ⱼ; . . . ; \vec{Y′}_{M}], j=1 . . . M′ where M′ is a number of recognized landmarks (M′≤M), \vec{Y′}ⱼ=[(λ−λⱼ)Rₑ·cos(ϕⱼ); (ϕ−ϕⱼ)Rₑ; h−hⱼ)]−rⱼ·\vec{R}·\vec{F}ⱼ, rⱼ=[{(λ−λⱼ)Rₑ·cos(ϕⱼ)}²+{(ϕ−ϕⱼ)Rₑ}²+{h−hⱼ}²]^{1/2}, \vec{R} and \vec{F}_{J} are calculated as in algorithm 1B.

In step 419, a query is made as to whether there is new data for error compensation. If so, step 420 is recursive estimation with the Kalman filter: \hat{\vec{X}}=\vec{K}·[\vec{Y}₁, \vec{Y}₂], \hat{\vec{X}}=[Δλ, Δϕ, Δh, \vec{ΔV}, \vec{ΔΨ}, \vec{ΔB}], \vec{ΔΨ}=[ΔRoll, ΔPitch, ΔYaw] is a vector of orientation angle errors, \vec{ΔB} is a vector of IMU errors, \vec{K} is a matrix of gain coefficients, and step 421 is error compensation for longitude λ, latitude ϕ, altitude h, Roll, Pitch, Yaw, and linear speed \vec{V}. Step 421 constitutes a determination of adjusted IMU output. Thereafter, or when there is no new data for error compensation in step 419, step 422 is output parameters: longitude λ, latitude ϕ, altitude h, Roll, Pitch, Yaw, and linear speed \vec{V}. In step 423, a query is made as to whether to terminate operation, and if so, step 424 is the end. If not, the process returns to step 403. Some or all of steps 406-421 may be considered to constitute an overall step of adjusting, using a processor, derived current vehicle position (step 405 determined using an earlier known vehicle position and movement therefrom) to obtain a corrected current vehicle position (by compensating for errors in output from the IMU).

An important aspect of this technique is based on the fact that much in the infrastructure is invariant and once it is accurately mapped, a vehicle with one or more mounted cameras can accurately determine its position without the aid of satellite navigation systems. This accurate position is used for any known purposes, e.g., display vehicle location on a display of a navigation system.

Initially, a map will be created basically by identifying objects in the environment near a road and, through a picture taking technique, determining the location of each of these objects using photogrammetry as described in International Pat. Appl. No. PCT/US14/70377 and U.S. Pat. No. 9,528,834. The map can then be used by an at least partly vehicle-resident route guidance system to permit the vehicle to navigate from one point to another.

Using this photogrammetry technique, a vehicle can be autonomously driven such that it does not come close or and ideally not impact with any fixed objects on or near the roadway. For autonomous operation, the vehicle component being controlled based on the position determination includes one or more of the vehicle guidance or steering system 96, the vehicle throttle system including the engine 98, the vehicle braking system 94 (see FIG. 3A), and any other system needed to be controlled based on vehicle position to allow for autonomous operation. The manner in which the vehicle braking system 94, vehicle guidance or steering system 96 and engine 98 can be controlled based on vehicle position (relative to the map) to guide the vehicle along a route to a destination (generally referred to as route guidance) is known to those skilled in the art to which this invention pertains.

For route guidance, instead of using the corrected current vehicle position to display on a display of a navigation system, such as on laptop 80, the corrected current vehicle position is input to one or more of the vehicle component control systems to cause them to change their operation, e.g., turn the wheels, slow down. When displayed on navigation system, e.g., laptop 80 or another system in the vehicle, the content of the display is controlled based on the corrected current vehicle position to show rods, landmarks, terrain, etc. around the corrected current vehicle location.

Since this technique will generate maps accurate to within a few centimeters, it should be more accurate than existing maps and thus appropriate for autonomous vehicle guidance even when visibility is poor. Location of the vehicle during the map creation phase will be determined by GNSS satellites and a differential correction system. If RTK differential GNSS is available, then the vehicle location accuracy can be expected to be within a few centimeters. If WADGNSS is used, then accuracy is on the order of decimeters.

Once the map is created, a processing unit in the vehicle has the option of determining its location, which is considered location of the vehicle, based on landmarks represented in the map database. The method by which this can be done is described below. Exemplifying, but non-limiting and non-exclusive steps for such a process can be:
1. Take a picture of the environment around the vehicle.
2. From a vehicle-resident map database, determine identified landmarks (Landmarks) which should be in the picture and their expected pixel locations.
3. Locate the pixel of each identified landmark as seen in picture (Note that some landmarks may be blocked by other vehicles).
4. Determine the IMU coordinates and pointing direction of each vehicle camera assembly from which the picture was obtained.
5. For each landmark, compose an equation containing the errors as unknowns of each IMU coordinate (3 displacements and 3 angles) which will correct the IMU coordinates so that the map pixel will coincide with the picture pixel.
6. Use more equations than the 6 IMU error unknowns, for example 10 landmarks.
7. Solve for the error unknowns using the Simplex or other method to get the best estimate of the errors in each coordinate and (if possible) an indication of which landmarks have the most inaccurate map locations.
8. When the pixels coincide based on the new corrections, correct the IMU with the new error estimates. This is similar to correcting using GNSS signals with DGNSS corrections.
9. Record the new coordinates of the landmarks which are most likely to be the least accurate which can be used to correct the map and upload these to the remote site.

This process can be further explained from the following considerations.
1. Since there will be two equations for every landmark, one for the vertical pixel displacement in the image and one for the lateral pixel displacement, only 3 landmarks are needed to solve for the IMU errors.
2. If we use 4 landmarks (4(n) objects taken 3(r) at a time) we get (n!/(n−r)!*r!)=4 estimates for the IMU errors and for 10 we get 120.
3. Since there can be a large number of sets of IMU error estimates for a few landmarks, the problem is to decide which set to use. It is beyond to scope of this description but the techniques are known to those skilled in the art. Once a choice is made, a judgment as to the map position accuracy of the landmarks can be made and the new pictures can be used to correct the map errors. This will guide selection of pictures to upload for future map corrections.
4. The error formulas could be in the form ex*vx+ey*vy+ez*vz+ep*vp+er*vr+ew*vw=dx where
   1. ex=the unknown IMU error in the longitudinal direction
   2. ey=the unknown IMU error in the vertical direction
   3. ez=the unknown IMU error in the lateral direction
   4. ep=the unknown IMU error in the pitch angle
   5. er=the unknown IMU error in the roll angle
   6. ew=the unknown IMU error in the yaw angle
   7. vx etc=the derivatives of the various coordinates and angles with respect to the x pixel location
   8. dx=the difference in the map and picture landmark lateral pixel location (this will be a function of the pixel angles)
   9. There is a similar equation for dy.

Using the above process, a processing unit on a vehicle, in the presence of or knowledge about mapped landmarks, can rapidly determine its position and correct the errors in its IMU without the use of GNSS satellites. Once a map is in place, the vehicle is immune to satellite spoofing, jamming, or even the destruction of satellites as might occur in wartime. In fact, only a single mapped landmark is required, provided at least three images are made of the landmark from three different locations. If three landmarks are available in an image, then only a single image is required for the vehicle to correct its IMU. The more landmarks in a picture and the more pictures of particular landmarks results in a better estimation of the IMU errors.

To utilize this method of vehicle location and IMU error correction, landmarks must be visible to the vehicle camera assemblies. Normally, the headlights will provide sufficient illumination for nighttime driving. As an additional aid, near IR floodlights such as 180 in FIGS. 5A, 5B and 5C can be provided. In such a case, the camera assemblies would need to be sensitive to near IR frequencies.

### 6. System Implementation

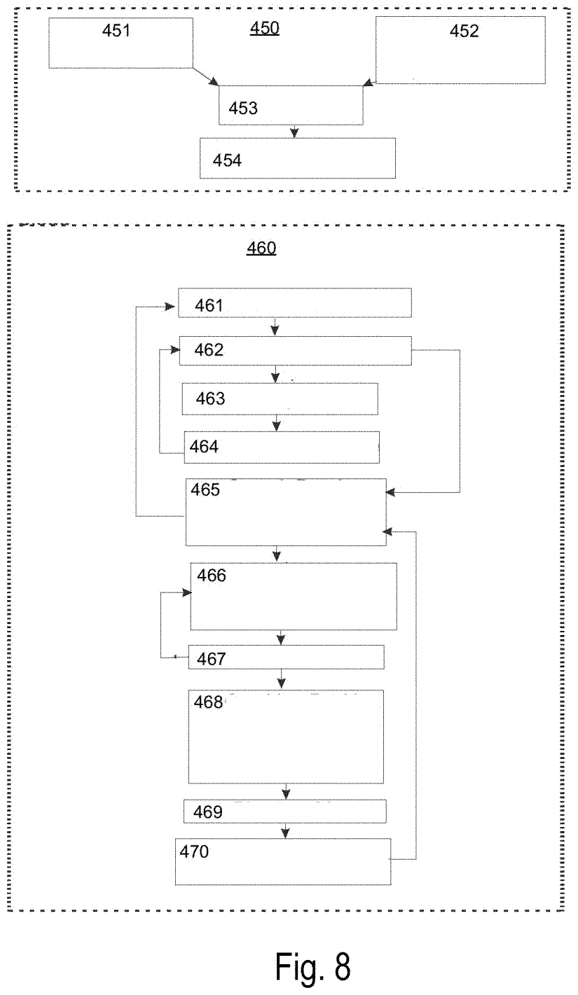

FIG. 8 is a flow chart with calculations performed in the “cloud” for a map creation method in accordance with the invention. The steps are listed below:

On the vehicle 450, the following steps occur: Step 451, acquire Image; Step 452, acquire IMU Angles and Positions; Step 453, compress the acquired data for transmission to the cloud; and Step 454, send the compressed data to the cloud

In the cloud 460, the following steps occur: Step 461, receive an image from a mapping vehicle; Step 462, identify a landmark using a pattern recognition algorithm such as neural networks, Step 463, assign ID when a landmark is identified; Step 464, store the landmark and the assigned ID in a database; and when there are no identified landmarks, Step 465, search the database for multiple same ID entries. If there are none, the process reverts to step 461. If there are multiple ID entries in the database as determined in step 465, step 466 is to combine a pair to form a position estimate by calculating the intersection of vectors passing thought a landmark reference point.

An important aspect of the invention is use of two pictures, each including the same landmark, and calculation of position of a point on the landmark from the intersection of two vectors drawn based on the images and known vehicle location when each image was acquired. It is stereo vision where the distance between the stereo cameras is large and thus accuracy of the intersection calculation is great. Coupled with the method of combining images (n*(n−1)/2), highly accurate positional determination is obtained with only one pass and perhaps 10 images of a landmark.

Step 467 is a query as to whether there are more pairs, and if so, the process returns to step 466. If not, the process proceeds to step 468, combining position estimates to find most probable location of the vehicle, step 469, placing the vehicle location on a map, and Step 470, making updated map data available to vehicles. From step 470, the process returns to step 465.

The system processing depicted in FIG. 8 will generally be in use during early stages of map creation. Since many landmarks have not been selected, it is desirable to retain all images acquired to allow retroactively searching for new landmarks which have been added. When the map is secure and no new landmarks are added, the need for retention of the entire images will no longer be necessary and much of the data processing can take place on the vehicle (not in the cloud) and only limited data transferred to the cloud. At this stage, the bandwidth required will be dramatically reduced as only landmark information is transmitted from the vehicle 450 to the cloud 460.

The cloud 460 represents a location remote from the vehicle 450, most generally, an off-vehicle location which communicates wirelessly with the vehicle 450. The cloud 460 is not limited to entities commonly considered to constitute the cloud and may be any location separate and apart from the vehicle at which a processing unit is resident.

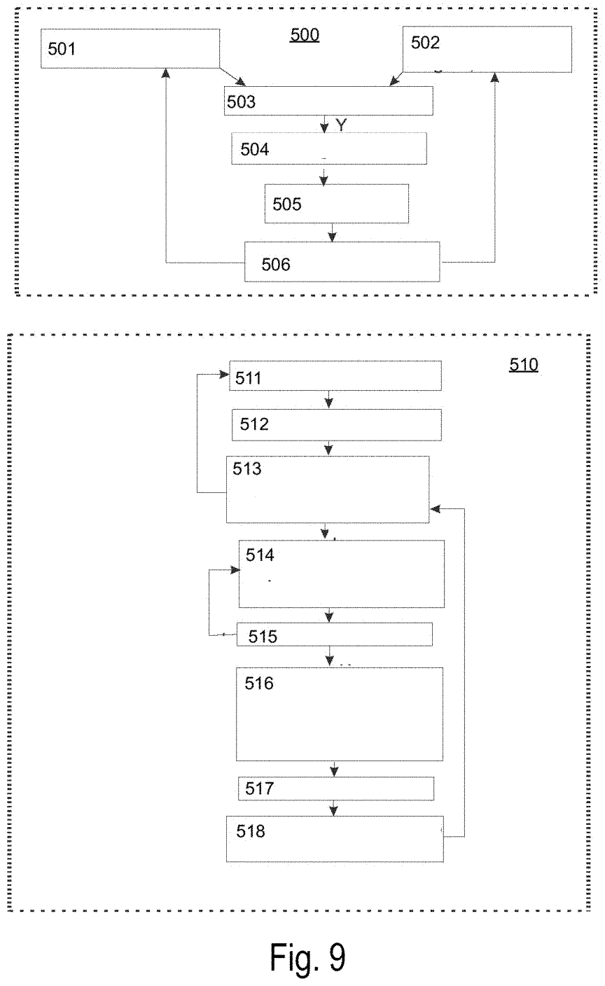

FIG. 9 is a flowchart with calculations performed on a vehicle for image compression. The steps are listed below:

On the vehicle 500, the following steps occur:

Step 501, acquire Image;

Step 502, acquire IMU Angles and Positions from which the image was acquired;

Step 503, identify a Landmark using a pattern recognition algorithm such as neural networks;

Step 504, assign an ID to the identified Landmark;

Step 505, compress the acquired data for transmission to the cloud; and

Step 506, send the compressed acquired data to the cloud.

In the cloud, the following steps occur:

Step 511, receive an image;

Step 512, store the received image in a database;

Step 513, search the database for multiple identical ID entries, and when one is found,

Step 514, combine a pair to form a position estimate. If no multiple identical ID entries are found, additional images are received in step 511.

A query is made in step 515 as to whether there are more pairs of multiple identical ID entries and if so, each is process in step 514, If not, in step 516, position estimates to find most probable location (of the vehicle) are combined and in step, 517, the vehicle location is placed on a map. In step 518, the updated map is made available to vehicles.

Once the map has been created and stored in a map database on the vehicle 500, essentially the only transmissions to the cloud 510 will relate to changes or accuracy improvements to the map. This will greatly reduce the bandwidth requirements at a time that the number of vehicles with the system is increasing.

### 7. Image Distortions

Several distortions can arise in an image taken of the scene by a camera assembly. Some are due to aberrations in the lens of the camera assembly which are local distortions caused when the lens contains an imperfect geometry. These can be located and corrected for by taking a picture of a known pattern and seeing where the deviations from that known pattern occur. A map can be made of these errors and the image corrected using that map. Such image correction would likely be performed during processing of the image, e.g., as a sort of pre-processing step by a processing unit receiving the image from a camera assembly.

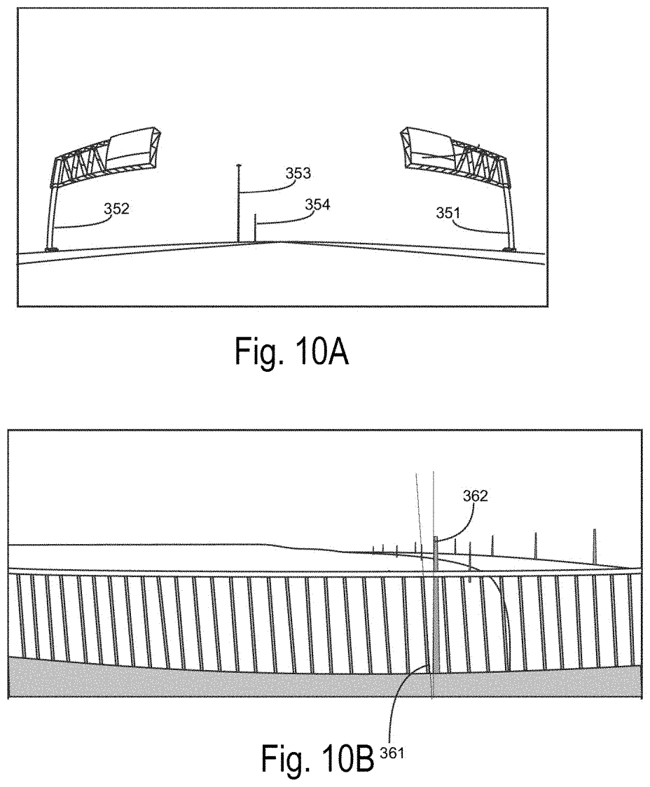

Barrel distortions are caused by distortions arising from use of a curved lens to create a pattern on a flat surface. They are characterized by a bending of an otherwise straight line as illustrated in FIG. 10A. In this case, straight poles 351, 352 on lateral sides of the image are bent toward the center of the image while poles 353, 354, already located in or near the center, do not exhibit such bending. This distortion is invariant with the lens and can also be mapped out of an image. Such image correction would likely be performed during processing of the image, e.g., as a sort of pre-processing step by a processing unit receiving the image from a camera assembly.

Cameras generally have either a global or a rolling shutter. In the global shutter case, all of the pixels are exposed simultaneously, whereas in the rolling shutter case, first the top row of pixels are exposed and the data transferred off of the imaging chip and then the second row pixels are exposed etc. If the camera is moving while the picture is being taken in the rolling shutter case, vertical straight lines appear to be bent to the left as shown by nearby fence pole 361 compared with distant pole 362 in FIG. 10B. The correction for rolling shutter caused distortion is more complicated since the amount of distortion is a function of, for example, shutter speed, vehicle velocity and distance of the object from the vehicle. Shutter speed can be determined by clocking the first and last data transferred from the camera assembly. Vehicle speed can be obtained from the odometer or the IMU, but the distance to the object is more problematic. This determination requires the comparison of more than one image and the angle change which took place between two images. By triangulation, knowing the distance that the vehicle moved between the two images allows the determination of the distance to the object.

By above methods, known distortions can be computationally removed from the images.

An important part of some embodiments of the invention is the digital map that contains relevant information relating to the road on which the vehicle is traveling. The digital map of this invention usually includes location of the edge of the road, edge of the shoulder, elevation and surface shape of the road, he character of the land beyond the road, trees, poles, guard rails, signs, lane markers, speed limits, etc. as discussed elsewhere herein. These data or information is acquired in a unique manner for use in the invention and the method for acquiring the information either by special or probe vehicles and its conversion to, or incorporation into, a map database that can be accessed by the vehicle system is part of this invention.

The maps in the map database may also include road condition information, emergency notifications, hazard warnings and any other information which is useful to improve the safety of the vehicle road system. Map improvements can include the presence and locations of points of interest and commercial establishments providing location-based services. Such commercial locations can pay to have an enhanced representation of their presence along with advertisements and additional information which may be of interest to a driver or other occupant of the vehicle. This additional information could include the hours of operation, gas price, special promotions etc. Again, the location of the commercial establishment can be obtained from the probe vehicles and the commercial establishment can pay to add additional information to the map database to be present to the vehicle occupant when the location of the establishment is present on the map being displayed in the display of the navigation system.

All information regarding the road, both temporary and permanent, should be part of the map database, including speed limits, presence of guard rails, width of each lane, width of the highway, width of the shoulder, character of the land beyond the roadway, existence of poles or trees and other roadside objects, location and content of traffic control signs, location of variable traffic control devices, etc. The speed limit associated with particular locations on the maps may be coded in such a way that the speed limit can depend upon the time of day and/or the weather conditions. In other words, speed limit may be a variable that will change from time to time depending on conditions.

It is contemplated that there will be a display for various map information which will always be in view for the passenger and/or driver at least when the vehicle is operating under automatic control. Additional user information can thus also be displayed on this display, such as traffic conditions, weather conditions, advertisements, locations of restaurants and gas stations, etc.

Very large map databases can now reside on a vehicle as the price of memory continues to drop. Soon it may be possible to store the map database of an entire country on the vehicle and to update it as changes are made. The area that is within, for example, 1000 miles from the vehicle can certainly be stored and as the vehicle travels from place to place the remainder of the database can be updated as needed though a connection to the Internet, for example.

When mention is made of the vehicle being operative to perform communications functions, it is understood that the vehicle includes a processor, processing unit or other processing functionality, which may be in the form of a computer, which is coupled to a communications unit including at least a receiver capable of receiving wireless or cellphone communications, and thus this communications unit is performing the communications function and the processor is performing the processing or analytical functions.

If the output of the IMU pitch and roll sensors are additionally recorded, a map of the road topography can be added to the map to indicate the side to side and forward to rear slopes in the road. This information can then be used warn vehicles of unexpected changes in road slope which may affect driving safety. It can also be used along with pothole information to guide the road management as to where repairs are needed.

Many additional map enhancements can be provided to improve highway safety. Mapping cameras described herein can include stoplights in their field of view and as the vehicle is determined to be approaching the stoplight, i.e., is within a predetermined distance which allows the camera to determine the status of the stoplight, and, since the existence of the stoplight will be known by the system, as it will have been recorded on the map, the vehicle will know when to look for a stoplight and determine the color of the light. More generally, a method for obtaining information about traffic-related devices providing variable information includes providing a vehicle with a map database including the location of the devices, determining the location of the vehicle, and as the location of the vehicle is determined to be approaching the location of each device, as known in the database, obtaining an image of the device using for example, a vehicle-mounted camera. This step may be performed by the processor disclosed herein which interfaces with the map database and the vehicle-position determining system. Images are analyzed to determine status of the device, which entails optical recognition technology.

When RTK GNSS is available, a probe vehicle can know its location within a few centimeters and in some cases within one centimeter. If such a vehicle is traveling at less than 100 KPH, for example, at least three to four images can be obtained of each landmark near the road. From these three to four images, the location of each landmark can be obtained to within 10 centimeters which is sufficient to form an accurate map of the roadway and nearby structures. A single pass of a probe vehicle is sufficient to provide an accurate map of the road without use of special mapping vehicles.

### 8. Summary

While the invention has been illustrated and described in detail in the drawings and the foregoing description, the same is to be considered as illustrative and not restrictive in character, it being understood that only preferred embodiments have been shown and described and that all changes and modifications that come within the spirit of the invention are desired to be protected.

1. A method for adjusting a vehicular component, comprising:
deriving, using a processor, information about current vehicle position from data obtained from an inertial measurement unit on the vehicle and an earlier known vehicle position;
adjusting, using the processor, the derived current vehicle position to obtain a corrected current vehicle position by:
obtaining images of an area external of the vehicle using at least one camera assembly on the vehicle, each of the at least one camera assembly being in a fixed relationship to the inertial measurement unit;
analyzing, using the processor, a plurality of the obtained images to derive positional information about a common landmark from a combination of two of the plurality of obtained images that include the common landmark, which constitutes image-derived positional information;
obtaining from a map database, positional information about the common landmark, which constitutes database-obtained positional information;
and
adjusting, using the processor, the derived current vehicle position based on any differences between the image-derived positional information and the database-obtained positional information to obtain the corrected current vehicle position; and
changing operation of the vehicular component based on the corrected current vehicle position to cause operation of the vehicular component to be different as a result of adjustment of the derived current vehicle position to the corrected current vehicle position.

2. The method of claim 1, wherein the step of adjusting, using the processor, the derived current vehicle position to obtain the corrected current vehicle position comprises changing the manner in which the processor derives information about the current vehicle position from the data obtained from the inertial measurement unit and the earlier known vehicle position.

3. The method of claim 1, wherein the step of changing the vehicular component based on the corrected current vehicle position comprises displaying the corrected current vehicle position on a display in the vehicle such that the vehicular component being changed is the display.

4. The method of claim 1, wherein the step of adjusting, using the processor, the derived current vehicle position to obtain the corrected current vehicle position is performed only when satellite-based locating services are not available.

5. The method of claim 1, further comprising:
installing the map database in the vehicle and including in the installed map database, identification information about a plurality of landmarks and positional information about each of the plurality of landmarks,
the step of obtaining from the map database, positional information about the common landmark comprising providing the map database with the identification of the common landmark and obtaining in response, the positional information about the common landmark.

6. The method of claim 1, further comprising generating the map database by:
obtaining images of an area around travel lanes on which vehicles travel using at least one camera assembly on a mapping vehicle moving on the travel lanes,
identifying, using a processor, landmarks in the images obtained by the at least one camera assembly on the mapping vehicle,
determining a position of the mapping vehicle using a satellite positioning system such that the position at which each image is obtained by the at least one camera assembly on the mapping vehicle is accurately known, and
determining the position of each of the identified landmarks using photogrammetry in consideration of the determined mapping vehicle position when the image containing the landmark is obtained, the step of determining the position of each of the identified landmarks comprising:
obtaining images of an area around travel lanes on which vehicles travel using the at least one camera assembly on the mapping vehicle moving on the travel lanes until for each identified landmark, two images are obtained; and
calculating, using the processor, the position of the identified landmark from an intersection of two virtual vectors drawn to a common point on the landmark in the two images from the determined mapping vehicle location when each of the two images was acquired

7. The method of claim 6, wherein the step of obtaining images of an area around travel lanes on which vehicles travel using the at least one camera assembly on the mapping vehicle moving on the travel lanes comprises obtaining images until for each identified landmark, at least three images are obtained, and
the step of determining the position of each of the identified landmarks using photogrammetry in consideration of determined mapping vehicle position when the image containing the landmark is obtained comprises using real time kinematic (RTK) to provide estimates of the position of the landmark in all three of the obtained images.

8. The method of claim 1, wherein the step of analyzing, using the processor, the plurality of obtained images to derive positional information about the common landmark from the combination of two of the plurality of obtained images that include the common landmark comprises determining coordinates of the inertial measurement unit and pointing direction of the at least one camera assembly from which each of the two of the plurality of obtained images was obtained.

9. The method of claim 8, wherein the step of adjusting, using the processor, the derived current vehicle position based on any differences between the image-derived positional information and the database-obtained positional information to obtain the corrected current vehicle position comprises
composing, using a processor, a number of equations containing errors as unknowns of each coordinate of the inertial measurement unit which correct the coordinates so that the positional information about the common landmark obtained from the map database will coincide with the positional information about the common landmark derived from the two of the plurality of the obtained images, whereby the number of equations composed is larger than the number of unknown errors; and
solving the composed equations, using the processor, to determine the error unknowns.

10. The method of claim 1, wherein the step of obtaining images of the area external of the vehicle using the at least one camera assembly on the vehicle comprises obtaining a number n of images each including the common landmark, wherein n is greater than 2, and the step of analyzing, using the processor, the plurality of obtained images to derive positional information about the common landmark from the combination of two of the plurality of obtained images that include the common landmark comprises:
calculating a plurality of estimates of the position of the common landmark, using a processor, each from a different combination of two of the plurality of obtained images;
deriving, using the processor, the positional information about the common landmark from the calculated estimates; and
when adjusting, using the processor, the derived current vehicle position based on any differences between the image-derived positional information and the database-obtained positional information to obtain the corrected current vehicle position, using the derived positional information about the common landmark from the calculated estimates.

11. The method of claim 10, wherein the step of calculating a plurality of estimates of the position of the common landmark, using the processor, each from a different combination of two of the plurality of obtained images, comprises calculating a number estimates which is (n*(n−1))/2 of the position of the common landmark.

12. The method of claim 1, further comprising identifying the common landmark in the two of the plurality of obtained images by
inputting each of the two of the plurality of obtained images to a neural network configured to output an identification of a known landmark upon receiving input of an image potentially containing a known landmark to thereby obtain an identification of the common landmark in the two of the plurality of obtained images.

13. The method of claim 1, wherein the at least one camera assembly is co-located with the inertial measurement unit.

14. A vehicular navigation system, comprising:
a display on which vehicle position is displayed;
an inertial measurement unit that obtains kinematic data about the vehicle;
at least one camera assembly that obtains images of an area external of the vehicle, each of said at least one camera assembly being in a fixed relationship to said inertial measurement unit;
a map database that contains positional information about landmarks in association with an identification of each of the landmarks; and
a processor that derives information about current vehicle position from the data obtained from said inertial measurement unit and an earlier known vehicle position and adjusting the derived current vehicle position to obtain a corrected current vehicle position based on processing of images obtained by said at least one camera assembly, said processor being configured to:
analyze a plurality of the obtained images to derive positional information about a common landmark from a combination of two of the plurality of obtained images that include the common landmark, which constitutes image-derived positional information;
obtain from the map database, positional information about the common landmark, which constitutes database-obtained positional information; and
adjust the derived current vehicle position based on any differences between the image-derived positional information and the database-obtained positional information to obtain the corrected current vehicle position; and
direct the display to display the corrected current vehicle position on the display.

15. The system of claim 14, wherein said processor analyzes the the plurality of obtained images to derive positional information about the common landmark from the two of the plurality of obtained images by determining coordinates of said inertial measurement unit and pointing direction of said at least one camera assembly from which each of the two of the plurality of obtained images was obtained.

16. The system of claim 15, wherein said processor adjusts the derived current vehicle position based on any differences between the image-derived positional information and the database-obtained positional information to obtain the corrected current vehicle position by
composing a number of equations containing errors as unknowns of each coordinate of said inertial measurement unit which correct the coordinates so that the positional information about the common landmark obtained from the map database will coincide with the positional information about the common landmark derived from the two of the plurality of the obtained images, whereby the number of equations composed is larger than the number of unknown errors; and
solving the composed equations, using said processor, to determine the error unknowns.

17. The system of claim 14, wherein said at least one camera assembly obtains images of the area external of the vehicle by obtaining a number n of images each including the common landmark, wherein n is greater than 2, and said processor analyzes the plurality of obtained images to derive positional information about the common landmark from the combination of two of the plurality of obtained images that include the common landmark by
calculating a plurality of estimates of the position of the common landmark, using a processor, each from a different combination of two of the plurality of obtained images;
deriving, using said processor, the positional information about the common landmark from the calculated estimates; and
when adjusting, using said processor, the derived current vehicle position based on any differences between the image-derived positional information and the database-obtained positional information to obtain the corrected current vehicle position, using the derived positional information about the common landmark from the calculated estimates.

18. The system of claim 17, wherein said processor is configured to calculate a plurality of estimates of the position of the common landmark, each from a different combination of two of the plurality of obtained images, by calculating a number estimates which is (n*(n−1))/2 of the position of the common landmark.

19. The system of claim 14, wherein said processor identifies common landmarks in the two of the plurality of obtained images by
inputting each of the two of the plurality of obtained images to a neural network configured to output an identification of a known landmark upon receiving input of an image potentially containing a known landmark to thereby obtain an identification of the common landmark in the two of the plurality of obtained images.

20. The system of claim 14, wherein said at least one camera assembly is co-located with said inertial measurement unit.
